(19) United States
(12) Patent Application Publication
(10) Pub. No.: US 2026/0342861 A1
(43) Pub. Date: Oct. 29, 2026

(54) Methods And Apparatus For Improving Internet Protocol Multimedia Subsystem Message Flow In Mobile Communications

(71) Applicant: MediaTek Inc., Hsinchu City (TW)

(72) Inventors: Chien-Yi Wang, Hsinchu City (TW); Yu-Ching Tung, Hsinchu City (TW); Yuan-Chieh Lin, Hsinchu City (TW)

(73) Assignee: MediaTek Inc., Hsinchu City (TW)

(21) Appl. No.: 19/647,803

(22) Filed: Apr. 14, 2026

Related U.S. Application Data
(60) Provisional application No. 63/796,460, filed on Apr. 29, 2025.

(51) Int. Cl. H04L 65/1016; H04L 65/1104; H04W 8/22; H04W 60/04

(52) U.S. Cl. CPC H04L 65/1016; H04L 65/1104; H04W 8/22; H04W 60/04

(57) ABSTRACT

Methods and apparatus for optimized Internet Protocol Multimedia Subsystem (IMS) message flow for voice services over Geostationary Earth Orbit (GEO) Non-Terrestrial Networks (NTN) are disclosed. A User Equipment (UE) may incorporate IMS registration information within a Non-Access Stratum (NAS) Attach Request message transmitted over a Control Plane Signaling Radio Bearer (SRB). A Mobility Management Entity (MME) may perform IMS registration on behalf of the UE. The voice call setup signaling may be transmitted as binary-encoded Session Initiation Protocol (SIP) messages within NAS Information Transfer messages over the Control Plane. The voice media may be transferred as Real-time Transport Protocol (RTP) packets over a default bearer using Non-IP Data Delivery (NIDD). The disclosed methods can reduce signaling overhead to meet the call setup Key Performance Indicator (KPI) for GEO NTN environments.

### CROSS REFERENCE TO RELATED PATENT APPLICATION(S)

The present disclosure is part of a non-provisional application claiming the priority benefit of U.S. Application No. 63/796,460, filed 29 Apr. 2025, the content of which herein being incorporated by reference in its entirety.

### TECHNICAL FIELD

The present disclosure is generally related to mobile communications and, more particularly, to improving Internet Protocol Multimedia Subsystem (IMS) message flow for voice services in mobile communications.

### BACKGROUND

Unless otherwise indicated herein, approaches described in this section are not prior art to the claims listed below and are not admitted as prior art by inclusion in this section.

Internet Protocol Multimedia Subsystem (IMS) is a standardized framework within the 3rd Generation Partnership Project (3GPP) for delivering voice and multimedia services over mobile and satellite networks. IMS voice calls rely on the Session Initiation Protocol (SIP) for call control signaling and on the Real-time Transport Protocol (RTP) for media packet delivery. Under conventional 3GPP specifications, an IMS Packet Data Network (PDN) connection is established with one default bearer and one dedicated bearer, both transmitted over Data Radio Bearers (DRBs).

In Geostationary Earth Orbit (GEO) Non-Terrestrial Network (NTN) environments, however, the resource constraints and high propagation delays of satellite links present fundamental challenges to conventional IMS signaling architectures. GEO satellite access suffers from one-way signal propagation delays of approximately 280 milliseconds and extremely limited available data rates of approximately 1 to 3 kilobits per second. Under conventional procedures, a single SIP INVITE message may reach approximately 2,000 bytes in size, and the cumulative data transfer required to complete an IMS call setup procedure may reach approximately 10,000 bytes. At the available data rates of GEO NTN links, such data volumes result in IMS call setup times exceeding 90 seconds under existing approaches, which are fundamentally incompatible with the call setup Key Performance Indicator (KPI) defined by 3GPP for voice services.

Accordingly, how to reduce call setup times for the GEO NTN scenarios becomes an important issue in the newly developed wireless communication network. Therefore, there is a need to provide proper schemes for improving the IMS message flow.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to improving IMS message flow for voice services in mobile communications.

In one aspect, a method may involve an apparatus including, by a processor of the apparatus, IMS registration information in a Non-Access Stratum (NAS) attach request message. The method may also involve the apparatus transmitting, by the processor, the NAS attach request message to a network. The method may further involve the apparatus receiving, by the processor, a NAS attach accept message from the network. The NAS attach accept message may comprise IMS notification information.

In one aspect, a method may involve an apparatus encoding, by a processor of the apparatus, a SIP INVITE message using a binary encoding scheme to produce an encoded INVITE message. The method may also involve the apparatus transmitting, by the processor, the encoded SIP INVITE message over a NAS uplink (UL) information transfer signaling to a network. The method may further involve the apparatus receiving, by the processor, a SIP response message encoded using the binary encoding scheme over a NAS DL information transfer signaling from the network.

In another aspect, a method may involve a network node receiving, by a processor of the network node, a NAS attach request message comprising IMS registration information. The method may also involve the network node performing, by the processor, an IMS registration with a core network based on the IMS registration information. The method may further involve the network node transmitting, by the processor, a NAS attach accept message comprising IMS notification information.

It is noteworthy that, although description provided herein may be in the context of certain radio access technologies, networks and network topologies such as LTE, LTE-Advanced, LTE-Advanced Pro, 5G, NR, 5G-Advanced, Internet-of-Things (IoT), Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale, as some components may be shown to be out of proportion than the size in actual implementation in order to clearly illustrate the concept of the present disclosure.

FIG. 1A illustrates a schematic system diagram of an example NTN architecture in which a GEO satellite operates as a relay node without on-board processing capabilities, in accordance with aspects of the present disclosure.

FIG. 1B illustrates a schematic system diagram of an example NTN architecture in which a GEO satellite is equipped with full core network functionalities and optionally IMS functionalities on board, in accordance with aspects of the present disclosure.

FIG. 2 illustrates an example IMS registration procedure in accordance with implementations of the present disclosure.

FIG. 3 is a block diagram of an example optimized call setup and voice media transfer procedure in accordance with an implementation of the present disclosure.

FIG. 4 is a flowchart of an example I1 binary encoding scheme in accordance with an implementation of the present disclosure.

FIG. 5 is a block diagram of an example communication system in accordance with an implementation of the present disclosure.

FIG. 6 is a flowchart of another example process in accordance with an implementation of the present disclosure.

FIG. 7 is a flowchart of another example process in accordance with an implementation of the present disclosure.

FIG. 8 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to improving IMS message flow. According to the present disclosure, a number of possible solutions may be implemented separately or jointly. That is, although these possible solutions may be described below separately, two or more of these possible solutions may be implemented in one combination or another.

The techniques described in the disclosure may be applied to a variety of telecommunication systems utilizing IMS communication services, such as current 4G and 5G communications systems, or a next-generation communications system (e.g., 6G). The IMS media described in the disclosure are not limited to voice but also include any real-time media types such as video, text, and applications. The UEs involved in the disclosure are not limited to mobile phones but can also include any device capable of providing IMS communication services, such as wearable devices, vehicular devices, Internet of Things (IoT) devices, and so on.

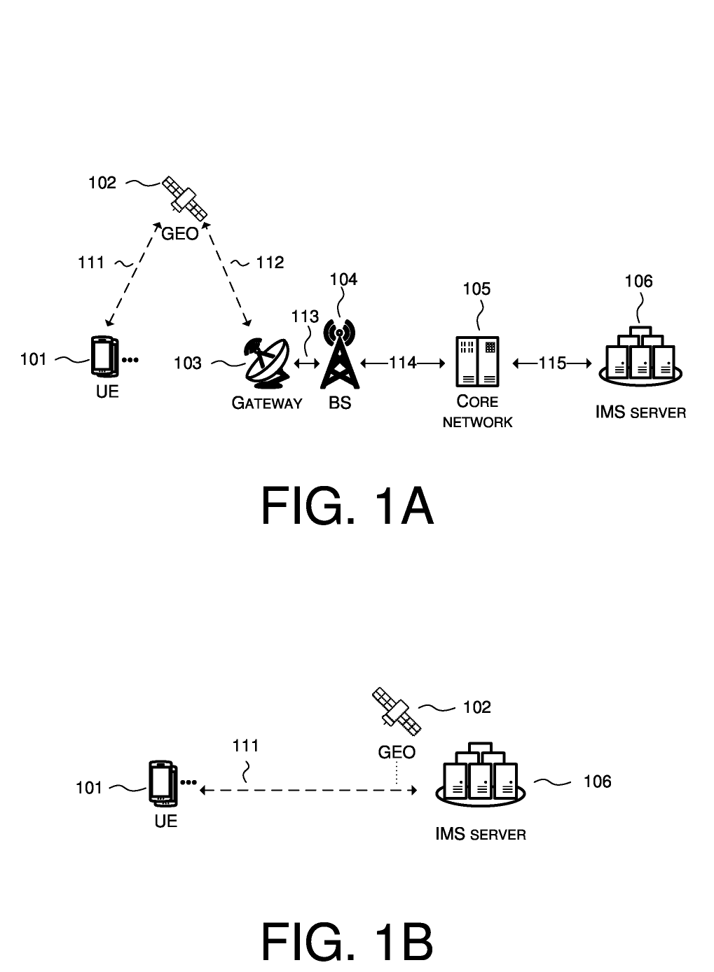

FIGS. 1A and 1B illustrate two schematic system diagrams that illustrate two example 3rd Generation Partnership Project (3GPP) NTN (Non-Terrestrial Network) architectures in accordance with aspects of the present disclosure.

FIG. 1A illustrates an NTN architecture in which the GEO satellite 102 does not include on-board processing capabilities, such as base station functionalities and/or core network (CN) functionalities. In this configuration, the GEO satellite 102 operates primarily as a relay node. Taking the UE transmission (Tx) direction as an example, the UE 101 on the ground first transmits data to the GEO satellite 102 through the service link 111. The GEO satellite 102 then forwards the data to a gateway 103 through the feeder link 112. After reaching the terrestrial network, the data is processed by a base station (BS) 104 via link 113, a core network 105 via link 114, and finally arrives at the IMS server 106 via link 115. The core network 105 may correspond to an evolved packet core (EPC) in a 4G communications system, a 5G core (5GC) in a 5G communications system, or a 6G core (6GC) in a 6G communications system.

FIG. 1B illustrates an NTN architecture in which the GEO satellite 102 is equipped with full CN functionalities, and may additionally include IMS functionalities on board. In this configuration, the communication path between the UE 101 and the IMS server 106 includes at least one GEO service link 111, and the IMS server 106 may be deployed directly on the GEO satellite 102.

It should be noted that the present disclosure is not limited to the NTN architectures illustrated in FIGS. 1A and 1B. Rather, the present disclosure may also be applied to other NTN configurations in which one or more satellites function as intermediary nodes along the data path between the UE and the IMS server.

Note that UE 101 in FIGS. 1A and 1B may comprise one or more UEs, of which at least one UE operates as a mobile originating (MO) terminal of an IMS call through a terrestrial network (TN) and/or a non-terrestrial network (NTN), and at least one UE operates as a mobile terminating (MT) terminal of the same IMS call through a TN and/or an NTN.

The IMS call may be initiated between an MO UE and an MT UE according to one or more of 3GPP technical specifications, RFC 3261 Session Initiation Protocol (SIP), RFC 4566 Session Description Protocol (SDP), and RFC 3550 Real-time Transport Protocol (RTP).

In conventional 5G NR networks supporting voice services (e.g., Voice over New Radio (VoNR)), an IMS registration procedure is performed as a sequence of independent signaling stages, each of which must be completed before the subsequent stage may commence. Under this conventional approach, IMS registration is decoupled from the 5G core network registration procedure and relies exclusively on the User Plane (UP) path for all SIP signaling exchanges.

In the first stage of the conventional IMS registration procedure, the User Equipment (UE) performs a 5G core network registration by transmitting a Non-Access Stratum (NAS) Registration Request to the Access and Mobility Management Function (AMF) via the gNB over a Signaling Radio Bearer (SRB). During this NAS registration, the UE indicates its support for IMS voice services by including capability indicators in the UE capability information elements. Upon successful completion of the NAS registration, the AMF transmits a Registration Accept message to the UE. At this stage, however, no IMS-specific information has been conveyed, and no IMS PDU session has been established.

In the second stage, the UE initiates a dedicated IMS Protocol Data Unit (PDU) session establishment procedure, which is separate from and subsequent to the NAS registration procedure described above. The UE transmits a PDU Session Establishment Request specifying the IMS Data Network Name (DNN) to the AMF, which forwards the request to the Session Management Function (SMF). The SMF creates the PDU session and routes the associated User Plane traffic through the User Plane Function (UPF). As part of this PDU session establishment, the network assigns the UE an IP address and provides the address of the Proxy-Call Session Control Function (P-CSCF) to the UE via the Protocol Configuration Options (PCO) or extended PCO (ePCO) information elements. The IMS PDU session is assigned a non-Guaranteed Bit Rate (non-GBR) Quality of Service (QoS) flow with a 5G QoS Identifier (5QI) value corresponding to IMS signaling traffic. This IMS PDU session is carried exclusively over a Data Radio Bearer (DRB) via the User Plane path, traversing the gNB and the UPF and bypassing the AMF.

In the third stage, the UE initiates SIP-based IMS registration by transmitting a SIP REGISTER request over the IMS PDU session established in the second stage. The SIP REGISTER request is transmitted as a standard IP packet over the User Plane DRB, and is routed through the P-CSCF to the Interrogating-Call Session Control Function (I-CSCF), which queries the Home Subscriber Server (HSS) or Unified Data Management (UDM) function to retrieve authentication vectors and to select a Serving-Call Session Control Function (S-CSCF). The IMS network responds with a SIP 401 Unauthorized challenge message carrying authentication parameters. The UE then transmits a second SIP REGISTER request incorporating the computed authentication response. The S-CSCF verifies the response against the expected value stored in the HSS/UDM and, upon successful verification, downloads the subscriber profile and transmits a SIP 200 OK response to the UE via the I-CSCF and P-CSCF. Each of these SIP message exchanges is transmitted as a full-size SIP message over the User Plane DRB, incurring the full transmission overhead associated with plaintext SIP headers and IP encapsulation. The complete SIP IMS registration procedure thus requires a minimum of two full round-trip SIP exchanges over the User Plane, in addition to the signaling overhead of the preceding NAS registration and IMS PDU session establishment stages.

In the fourth stage, following successful IMS registration, voice media is transported during an IMS call over a dedicated GBR QoS flow with a 5QI value of one, established via a PDU session modification procedure. SIP call setup signaling during the call continues to be carried over the default IMS PDU session via the User Plane DRB, while Real-time Transport Protocol (RTP) voice packets are carried over the dedicated GBR QoS flow, also via the User Plane DRB.

The foregoing conventional VoNR IMS registration procedure is predicated on the availability of sufficient User Plane bandwidth and sufficiently low propagation latency to complete the multiple sequential signaling stages within an acceptable timeframe. In particular, the procedure requires the sequential completion of: (1) a NAS registration procedure; (2) a separate IMS PDU session establishment procedure over the User Plane; and (3) a SIP-based IMS registration procedure comprising at minimum two SIP round-trip exchanges, each carrying full-size SIP messages of approximately 1,000 to 2,000 bytes over the User Plane. In terrestrial 5G NR deployments, where User Plane round-trip times are on the order of milliseconds and available data rates are on the order of megabits per second, this multi-stage sequential procedure may be completed within approximately one second or less.

In GEO NTN environments, however, the foregoing conventional approach is fundamentally inadequate. GEO satellite links impose one-way propagation delays of approximately 280 milliseconds and constrain available data rates to approximately 1 to 3 kilobits per second. Under these conditions, the cumulative data volume required to complete the conventional NAS registration, IMS PDU session establishment, and two-round-trip SIP IMS registration procedure — transmitted entirely over the User Plane in standard IP-encapsulated SIP message format — results in IMS registration and call setup times exceeding 90 seconds. Such performance is incompatible with the 30-second call setup Key Performance Indicator (KPI) defined by 3GPP for voice services over GEO NTN, and renders conventional VoNR IMS registration architectures unsuitable for deployment in GEO NTN environments.

Furthermore, the conventional approach provides no mechanism for integrating IMS registration information with the NAS attachment procedure, no mechanism for conveying IMS registration parameters within NAS signaling messages, and no mechanism for delegating the SIP-based IMS registration exchange to a network node such as the Mobility Management Entity (MME) on behalf of the UE. Similarly, the conventional approach provides no mechanism for transporting voice RTP packets over a default bearer using Non-IP Data Delivery (NIDD) as an alternative to the dedicated GBR bearer with RTP over UDP over IP.

Accordingly, there exists a need for methods and apparatus that optimize the IMS registration and voice call setup procedures for GEO NTN or other constrained network environments by integrating IMS registration with the NAS attachment procedure, by transmitting SIP signaling over the Non-Access Stratum Control Plane path using binary encoding, and by transporting voice media over a default bearer via Non-IP Data Delivery, so as to meet the 3GPP-defined call setup KPI under the severe bandwidth and latency constraints of satellite access.

In accordance with the present disclosure, an optimized IMS registration procedure is proposed for User Equipment (UE) operating over a GEO NTN, in which the IMS registration procedure is integrated with the NAS attachment procedure so as to eliminate the sequential signaling stages and cumulative User Plane data overhead that render the conventional VoNR IMS registration architecture unsuitable for GEO NTN environments.

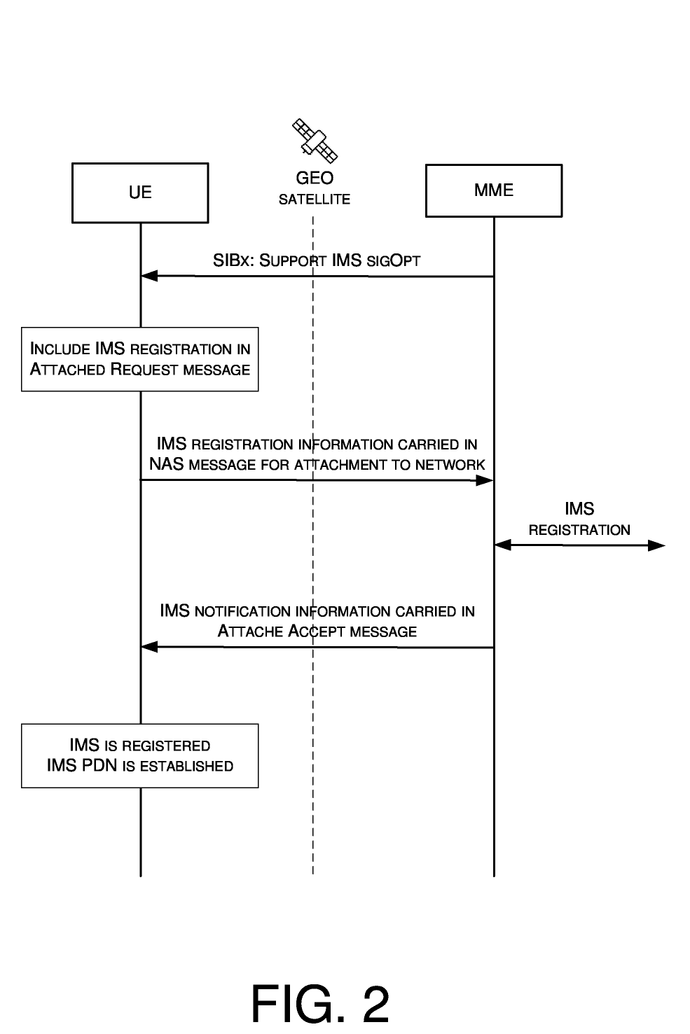

The optimized IMS registration procedure of the present disclosure is performed within an NTN system architecture comprising a UE, a GEO satellite acting as a transparent relay node, a base station (BS) on the ground, a Mobility Management Entity (MME), and an IMS Core network. FIG. 2 illustrates an example IMS registration procedure in accordance with the present disclosure.

The UE is a communication apparatus located on the ground and capable of establishing wireless connectivity to the network via a GEO satellite link. The UE may be any device capable of supporting IMS voice services, including but not limited to a smartphone, a tablet computer, a wearable device, or an Internet of Things (IoT) device. The GEO satellite operates as a transparent relay node between the UE and the terrestrial network infrastructure. In this transparent payload architecture, the GEO satellite relays radio frequency signals between the UE and the ground-based network equipment via a service link on the UE-facing side and a feeder link on the network-facing side. The network side may comprise a base station, which may be an evolved Node B (eNB) in a 4G Evolved Packet System (EPS) architecture, a next-generation Node B (gNB) in a 5G New Radio (NR) architecture or a base station in a 6G network architecture, is located on the ground and is connected to the GEO satellite via the feeder link. The MME is a core network node responsible for NAS signaling and mobility management in this architecture.

In the optimized IMS registration procedure of the present disclosure, the network may broadcast an IMS signaling optimization capability indicator to UEs within the coverage area. Specifically, the satellite may transmit a System Information Block (e.g., SIBx) that includes an IMS signaling optimization capability indicator (e.g., IMS sigOpt), indicating to UEs that the network supports the optimized IMS registration procedure described herein. Upon receiving the SIBx and detecting the presence of the IMS sigOpt capability indicator, the UE may determine that the optimized IMS registration procedure is available and proceed to incorporate IMS registration information into its NAS Attach Request message. In implementations in which the IMS sigOpt capability indicator is not present in the received SIBx, the UE may fall back to the conventional SIP-based IMS registration procedure over the User Plane. The IMS sigOpt capability indicator thus serves as a gating mechanism that enables network-controlled activation of the optimized IMS registration procedure on a per-cell basis, allowing the network to selectively enable the procedure in GEO NTN cells while maintaining backward compatibility with conventional IMS registration procedures in terrestrial cells.

Then, the UE may incorporate IMS registration information into a NAS Attach Request message, which is transmitted over the Control Plane (CP) Signaling Radio Bearer (SRB) to the Mobility Management Entity (MME). Under the conventional VoNR approach, such IMS registration information — including the IMS Public User Identity (IMPU) and the IMS Private Identity (IMPI) — is conveyed exclusively within SIP REGISTER messages transmitted over the User Plane Data Radio Bearer (DRB) as standard IP-encapsulated SIP packets, requiring a dedicated IMS PDU session to have been established prior to IMS registration. In the present disclosure, by contrast, the IMPU, IMPI, and any additional IMS registration parameters required to initiate the IMS registration procedure at the IMS core are embedded within the NAS Attach Request message itself, prior to IMS PDU session establishment and without the need for a separate SIP-based registration exchange between the UE and the IMS Core. The NAS Attach Request message carrying the IMS registration information is transmitted over the Control Plane SRB, which provides mandatory integrity protection and ciphering, and is routed through the radio access network to the MME. In some implementations, the NAS Attach Request message may further include a PDN Connectivity Request for the IMS Packet Data Network (PDN) connection with the Request Type set to "initial attach" (IA), so that the IMS PDN connection establishment is requested concurrently with the NAS attachment procedure without requiring a separate PDN connectivity request following attach completion.

On the network side, the MME may perform IMS registration to the IMS core on behalf of the UE, based on the IMS registration information received within the NAS Attach Request message. Upon receiving the NAS Attach Request message and extracting the IMS registration information embedded therein, the MME initiates and completes the IMS registration procedure with the IMS core using the extracted IMPU, IMPI, and any associated authentication parameters, without requiring the UE to directly exchange SIP REGISTER messages with the P-CSCF, I-CSCF, or S-CSCF. In this manner, the SIP-based IMS registration exchange — which in the conventional procedure requires a minimum of two full round-trip message exchanges between the UE and the IMS Core over the User Plane, each carrying full-size SIP messages of approximately 1,000 to 2,000 bytes — is replaced by a network-side procedure performed by the MME without any additional User Plane transmission by the UE. The MME thus acts as a proxy for the UE in the IMS registration procedure, leveraging the existing NAS Control Plane signaling infrastructure to convey the IMS registration parameters to the IMS core in a manner that is transparent to the UE and that does not require the UE to establish an IMS PDU session or a User Plane DRB prior to IMS registration.

Following successful IMS registration by the MME on behalf of the UE, the network transmits a NAS Attach Accept message to the UE over the Control Plane SRB. In the present disclosure, the NAS Attach Accept message carries IMS notification information indicating that IMS registration has been successfully completed and that the IMS PDU connection has been established. In some implementations, the IMS notification information carried in the NAS Attach Accept message may include one or more of: a confirmation of successful IMS registration, an assigned IMS contact address or binding, authentication result parameters, and the address of the P-CSCF allocated for subsequent IMS signaling. Upon receiving the NAS Attach Accept message and the IMS notification information contained therein, the UE may store the IMS registration state and the IMS PDN connection parameters, and consider itself to be IMS registered without having transmitted any SIP message over the User Plane.

As a result of the foregoing optimized IMS registration procedure, the UE completes both 5G core network attachment and IMS Core registration through a single NAS signaling exchange over the Control Plane SRB, and simultaneously establishes the IMS PDN connection, all within the latency and bandwidth constraints imposed by GEO NTN satellite access. This stands in contrast to the conventional VoNR approach, in which IMS registration requires three sequential signaling stages — NAS registration, IMS PDU session establishment, and SIP-based IMS registration — each generating User Plane data transfers that are individually incompatible with GEO NTN bandwidth constraints of approximately 1 to 3 kilobits per second. By integrating all three stages into a single NAS Control Plane exchange, the present disclosure substantially reduces the total data volume and number of round-trip exchanges required to complete IMS registration, thereby enabling IMS voice services to become available over GEO NTN within a timeframe compatible with the call setup KPI defined by the 3GPP.

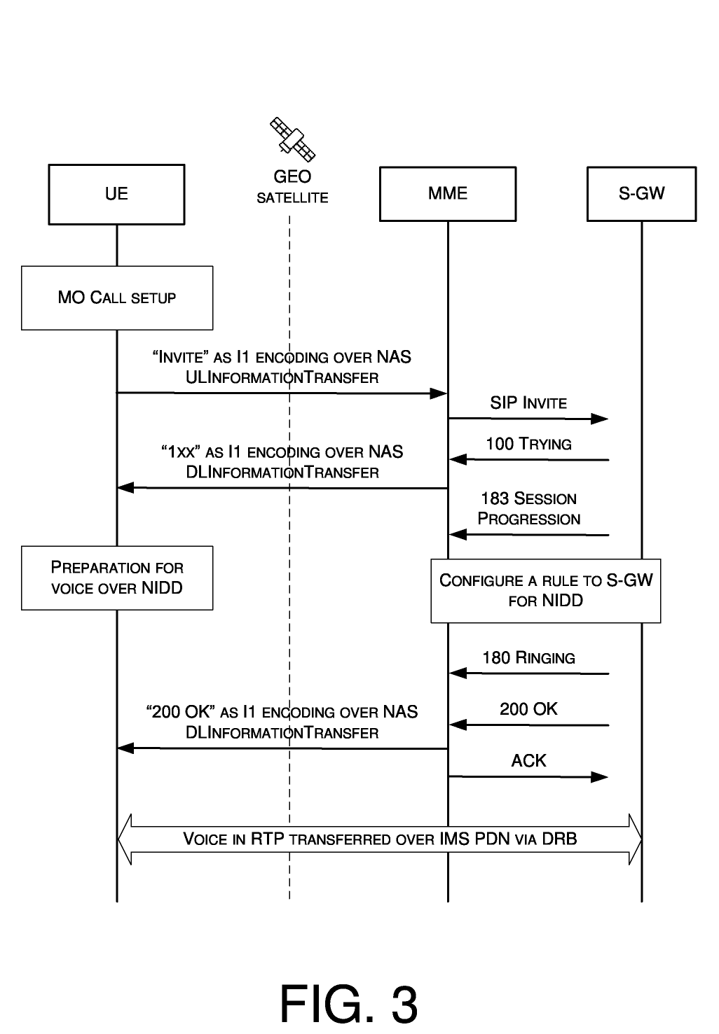

The optimized call setup and voice media transfer procedure of the present disclosure is performed within the same GEO NTN system architecture described above in connection with the optimized IMS registration procedure, with the addition of a Serving Gateway (S-GW) that participates in the voice media transfer path. FIG. 3 illustrates the signaling entities and transmission paths involved in the optimized call setup and voice media transfer procedure in accordance with the present disclosure.

In addition to the UE, the GEO satellite, the base station, and the MME described above, the system architecture for the call setup and voice media transfer procedure further comprises a Serving Gateway (S-GW). The S-GW is a User Plane gateway node in the Evolved Packet Core (EPC) that anchors the default EPS bearer of the IMS PDN connection and routes User Plane data packets between the radio access network and the Packet Data Network Gateway (P-GW). In the context of the present disclosure, the S-GW performs an extended function beyond its conventional User Plane forwarding role: prior to the commencement of voice media transfer, the S-GW is configured with a forwarding rule that enables it to handle voice Real-time Transport Protocol (RTP) packets encapsulated in Non-IP Data Delivery (NIDD) format over the default bearer of the IMS PDN connection, as described in further detail below.

The call setup procedure of the present disclosure utilizes two distinct transmission paths for the two types of traffic involved: the Non-Access Stratum Control Plane (NAS CP) path over the Signaling Radio Bearer (SRB) for SIP call setup signaling, and the User Plane (UP) path over the default Data Radio Bearer (DRB) of the IMS PDN connection for voice RTP media. The NAS CP path routes NAS messages carrying encoded SIP signaling from the UE through the base station, through the GEO satellite relay, and to the MME on the ground. The User Plane path for voice media routes NIDD-encapsulated RTP packets from the UE through the base station, the GEO satellite relay, and the S-GW to the remote endpoint. The separation of SIP call setup signaling onto the NAS CP path and voice RTP media onto the User Plane default bearer path is a novel aspect of the present disclosure and stands in contrast to conventional IMS call architectures, in which both SIP signaling and voice media are transmitted over User Plane Data Radio Bearers.

In accordance with the present disclosure, an optimized Mobile Originating (MO) call setup procedure is performed following the completion of the IMS registration procedure described above, in which all SIP call setup signaling is transmitted over the NAS Control Plane path using a binary encoding scheme, and voice media is transported over the default bearer of the IMS PDN connection using Non-IP Data Delivery (NIDD), thereby avoiding the User Plane data volume and dedicated bearer establishment overhead that render conventional IMS call setup architectures unsuitable for GEO NTN environments.

In the optimized call setup procedure, the UE encodes a SIP INVITE message using a binary encoding scheme and transmits the encoded SIP INVITE message to the MME within a NAS uplink (UL) Information Transfer message over the Control Plane SRB. In some implementations, the binary encoding scheme may be the I1 encoding scheme as defined in the 3GPP standards, which conveys a subset of key SIP message fields — including at least the dialing number and a call type indicator indicating whether the call is a voice call or a video call — in a compact binary format. By encoding the SIP INVITE message using the I1 binary encoding scheme and transmitting it within a NAS UL Information Transfer message over the Control Plane SRB, the present disclosure reduces the data volume associated with the SIP INVITE message from approximately 2,000 bytes in conventional full-size plaintext SIP format to a substantially smaller binary-encoded representation compatible with the 1 to 3 kilobits per second data rate constraint of the GEO NTN satellite link. The MME receives the NAS UL Information Transfer message, extracts the I1-encoded SIP INVITE message, and forwards the corresponding SIP INVITE to the IMS core via the standard IMS signaling interface.

Next, the IMS core processes the SIP INVITE and returns a SIP 100 Trying provisional response, indicating that the INVITE has been received and is being processed. The MME receives the SIP 100 Trying response from the IMS core, encodes it using the I1 binary encoding scheme, and transmits the encoded response to the UE within a NAS downlink (DL) Information Transfer message over the Control Plane SRB. In this manner, each SIP response message generated by the IMS core during the call setup procedure is encoded in binary format by the MME and delivered to the UE over the NAS Control Plane path, without requiring any User Plane DRB transmission for SIP signaling purposes.

The IMS core may further transmit a SIP 183 Session Progress message, indicating that end-to-end session parameters have been negotiated and that the media path is being prepared. Upon receiving the SIP 183 Session Progress message from the IMS core, the MME encodes the message using the I1 binary encoding scheme and delivers it to the UE within a NAS DL Information Transfer message over the Control Plane SRB. The receipt of the SIP 183 Session Progress message by the UE signals that sufficient session parameters are available to commence preparation for voice media transfer over NIDD.

Concurrent with or immediately following the receipt of the SIP 183 Session Progress indication, the MME may configure an NIDD forwarding rule to the S-GW. This configuration step instructs the S-GW to handle voice RTP packets encapsulated as Non-IP packets over the default bearer of the IMS PDN connection, enabling the default bearer to serve as the transmission path for voice media in lieu of the conventional dedicated GBR bearer. In some implementations, the NIDD forwarding rule configuration may specify one or more of: the identifier of the default IMS PDN bearer over which NIDD-encapsulated RTP packets are to be forwarded; the Non-IP packet encapsulation format to be applied; and the remote endpoint address and port parameters negotiated during SIP session establishment. The configuration of the NIDD forwarding rule in the S-GW prior to the commencement of voice media transfer ensures that the S-GW is prepared to correctly handle NIDD-encapsulated RTP packets upon receipt, without incurring the dedicated bearer establishment latency that would otherwise be required under conventional IMS media architectures.

Then, the IMS core transmits a SIP 180 Ringing message, indicating that the called party's device is alerting. The MME encodes the SIP 180 Ringing message using the I1 binary encoding scheme and delivers it to the UE within a NAS DL Information Transfer message over the Control Plane SRB.

Upon the called party accepting the call, the IMS Core transmits a SIP 200 OK final response. The MME encodes the SIP 200 OK message using the I1 binary encoding scheme and delivers it to the UE within a NAS DL Information Transfer message over the Control Plane SRB. The UE, upon receiving the encoded SIP 200 OK response, transmits a SIP ACK message encoded using the I1 binary encoding scheme within a NAS UL Information Transfer message over the Control Plane SRB, thereby completing the SIP handshake and establishing the IMS session.

Following the completion of the SIP session establishment, voice media is transmitted as RTP packets over the IMS PDN connection via the default bearer DRB. In the present disclosure, the RTP packets are encapsulated in NIDD format for transmission over the default bearer, rather than being encapsulated as RTP over UDP over IP as in the conventional dedicated bearer approach. The use of NIDD encapsulation for voice RTP packets over the default bearer of the IMS PDN connection eliminates the need to establish a dedicated GBR bearer for voice media, which in conventional IMS architectures requires an additional bearer establishment signaling exchange over the GEO NTN satellite link prior to the commencement of voice transmission. By pre-configuring the NIDD forwarding rule in the S-GW during the call setup procedure, as described above, the present disclosure enables voice RTP transmission to commence immediately upon completion of the SIP ACK exchange, without any additional bearer establishment delay.

The complete optimized call setup procedure of the present disclosure — from transmission of the I1-encoded SIP INVITE message over the NAS Control Plane to the completion of the SIP ACK exchange and commencement of NIDD-encapsulated voice RTP transmission — is designed to meet the 30-second call setup KPI defined by 3GPP for voice services over GEO NTN, by minimizing the total data volume of SIP signaling exchanged over the GEO NTN satellite link and by eliminating the dedicated bearer establishment procedure required under conventional IMS call architectures.

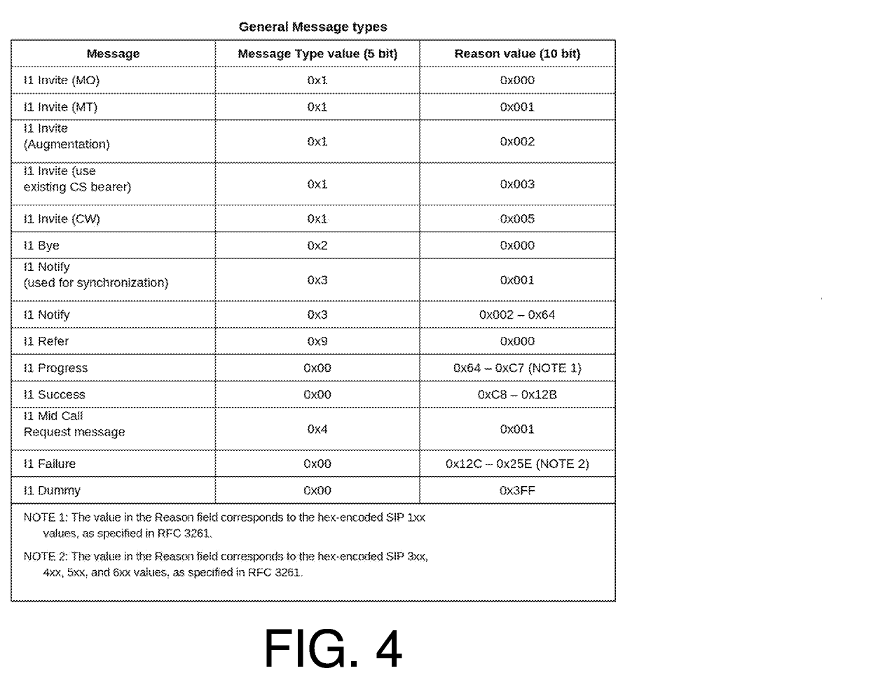

In accordance with the present disclosure, SIP call setup messages transmitted over the NAS Control Plane path may be encoded using the I1 binary encoding scheme, in order to reduce the data volume of each SIP message to a level compatible with the bandwidth constraints of GEO NTN satellite access. FIG. 4 illustrates an example embodiment of an I1 binary encoding scheme in accordance with the present disclosure. The I1 encoding scheme represents each SIP message as a compact binary structure comprising two primary fields: a five-bit Message Type value field that identifies the general category of the SIP message, and a ten-bit Reason value field that distinguishes specific message subtypes or SIP response codes within a given Message Type category. The mapping between SIP messages and their corresponding I1-encoded Message Type and Reason values is defined in the table of FIG. 4, entitled "General Message types," which specifies the binary representations for all SIP message types relevant to IMS call setup and teardown procedures.

In some implementations, the UE may encode a SIP INVITE message for an MO call using the I1 encoding scheme prior to transmission over the NAS Control Plane path. Pursuant to the table of FIG. 4, an I1 Invite message for an MO call is represented by a Message Type value of 0x1 and a Reason value of 0x000. In addition to the Message Type and Reason fields, the I1-encoded INVITE message may carry additional call parameters that are essential for call establishment but not derivable from the Message Type and Reason fields alone, including at least a dialing number identifying the called party and a call type indicator specifying whether the call is a voice call or a video call. These additional parameters are encoded in binary format within the I1 message payload in accordance with the field definitions of the 3GPP standards. The resulting I1-encoded INVITE message represents a substantially compressed binary equivalent of the corresponding full-size plaintext SIP INVITE message, which in conventional IMS implementations may reach approximately 2,000 bytes in length and contains numerous SIP header fields that are redundant or derivable from network context. By replacing the full-size SIP INVITE with its I1-encoded binary representation, the present disclosure reduces the uplink data volume for call initiation to a level compatible with the 1 to 3 kilobits per second data rate constraint of the GEO NTN satellite link.

In some implementations, the MME may encode SIP provisional and final response messages received from the IMS core using the I1 encoding scheme before delivering them to the UE within NAS DL Information Transfer messages over the Control Plane SRB. Specifically, SIP 1xx provisional response messages — including the SIP 100 Trying response and the SIP 183 Session Progress response — are encoded as I1 Progress messages, with a Message Type value of 0x00 and a Reason value corresponding to the hex-encoded SIP response code as specified in Note 1 of the table in FIG. 4, which states that the Reason field value corresponds to the hex-encoded SIP 1xx values as specified in RFC 3261. For example, the SIP 183 Session Progress response, which carries the decimal response code 183 corresponding to the hexadecimal value 0xB7, is encoded as an I1 Progress message with a Reason value of 0x0B7, and the SIP 180 Ringing response, corresponding to the hexadecimal value 0xB4, is encoded as an I1 Progress message with a Reason value of 0x0B4. Similarly, the SIP 100 Trying response, corresponding to the hexadecimal value 0x64, is encoded as an I1 Progress message with a Reason value of 0x064.

In some implementations, the SIP 200 OK final response message may be encoded as an I1 Success message pursuant to the table in FIG. 4. An I1 Success message is represented by a Message Type value of 0x00 and a Reason value in the range 0xC8 to 0x12B, corresponding to the hex-encoded SIP 2xx response codes as specified in Note 1 of the table in FIG. 4. Specifically, the SIP 200 OK response, carrying the decimal response code 200 corresponding to the hexadecimal value 0xC8, is encoded as an I1 Success message with a Reason value of 0xC8. The MME may transmit the I1-encoded SIP 200 OK message to the UE within a NAS DL Information Transfer message over the Control Plane SRB. Upon receiving the I1-encoded SIP 200 OK message, the UE may encode a SIP ACK message using the I1 encoding scheme and transmit the encoded ACK to the MME within a NAS UL Information Transfer message over the Control Plane SRB, thereby completing the SIP handshake.

By encoding all SIP call setup messages exchanged between the UE and the IMS core using the I1 binary encoding scheme as defined in the 3GPP standards, and by transporting all encoded messages within NAS Information Transfer messages over the Control Plane SRB, the present disclosure replaces the full-size plaintext SIP message exchanges of conventional IMS call setup architectures — which collectively require approximately 10,000 bytes of User Plane data transfer for a complete call setup procedure — with a sequence of compact binary-encoded NAS Control Plane messages whose aggregate data volume is compatible with the 1 to 3 kilobits per second bandwidth constraint of the GEO NTN satellite link, thereby enabling the complete call setup procedure to be performed within the 30-second call setup KPI defined by 3GPP for voice services over GEO NTN.

### Illustrative Implementations

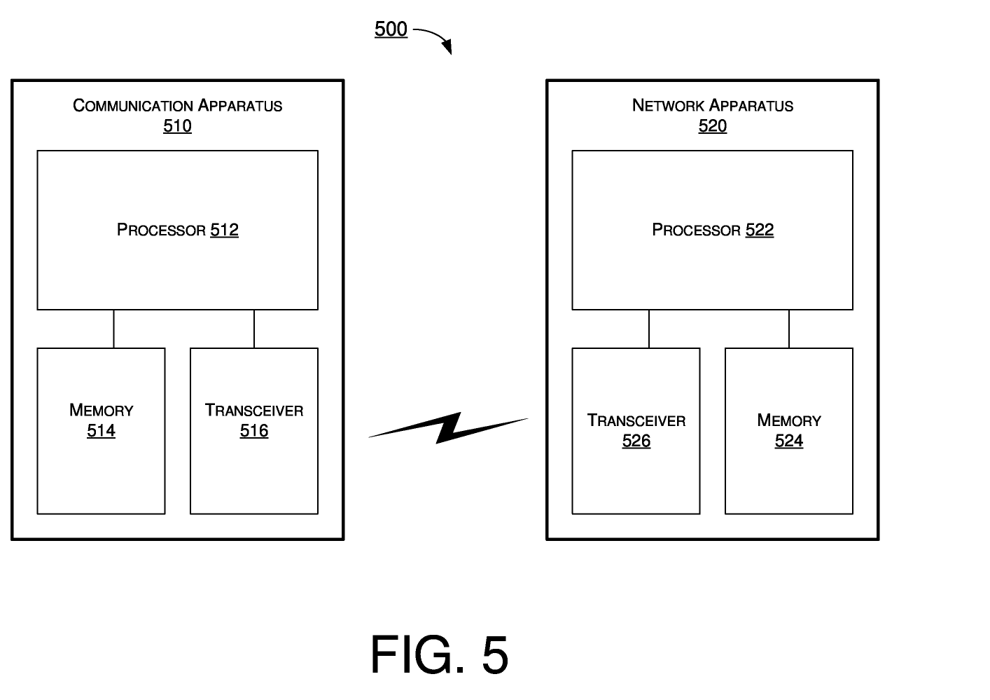

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to improving IMS message flow for voice services in mobile communications, including scenarios/schemes described above as well as processes 600, 700 and 800 described below.

Communication apparatus 510 may be a part of an electronic apparatus, which may be a UE such as a portable or mobile apparatus, a wearable apparatus, a wireless communication apparatus, or a computing apparatus. For instance, communication apparatus 510 may be implemented in a smartphone, a smartwatch, a personal digital assistant, a digital camera, or a computing equipment such as a tablet computer, a laptop computer, or a notebook computer. Communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of a network apparatus, which may be a network node such as a satellite, a base station, a small cell, a router, a gateway, or other network element. For instance, network apparatus 520 may be implemented in an eNodeB in an LTE network, in a gNB in a 5G/NR, IoT, NB-IoT or IIoT network or in a satellite or base station in a 6G network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including the proposed IMS message flow for voice services in accordance with various implementations of the present disclosure.

In some implementations, communication apparatus 510 may also include a transceiver 516 coupled to processor 512 and capable of wirelessly transmitting and receiving data. In some implementations, communication apparatus 510 may further include a memory 514 coupled to processor 512 and capable of being accessed by processor 512 and storing data therein. In some implementations, network apparatus 520 may also include a transceiver 526 coupled to processor 522 and capable of wirelessly transmitting and receiving data. In some implementations, network apparatus 520 may further include a memory 524 coupled to processor 522 and capable of being accessed by processor 522 and storing data therein. Accordingly, communication apparatus 510 and network apparatus 520 may wirelessly communicate with each other via transceiver 516 and transceiver 526, respectively.

To aid better understanding, the following description of the operations, functionalities and capabilities of each of communication apparatus 510 and network apparatus 520 is provided in the context of a mobile communication environment in which communication apparatus 510 is implemented in or as a communication apparatus or a UE and network apparatus 520 is implemented in or as a network node of a communication network.

### Illustrative Processes

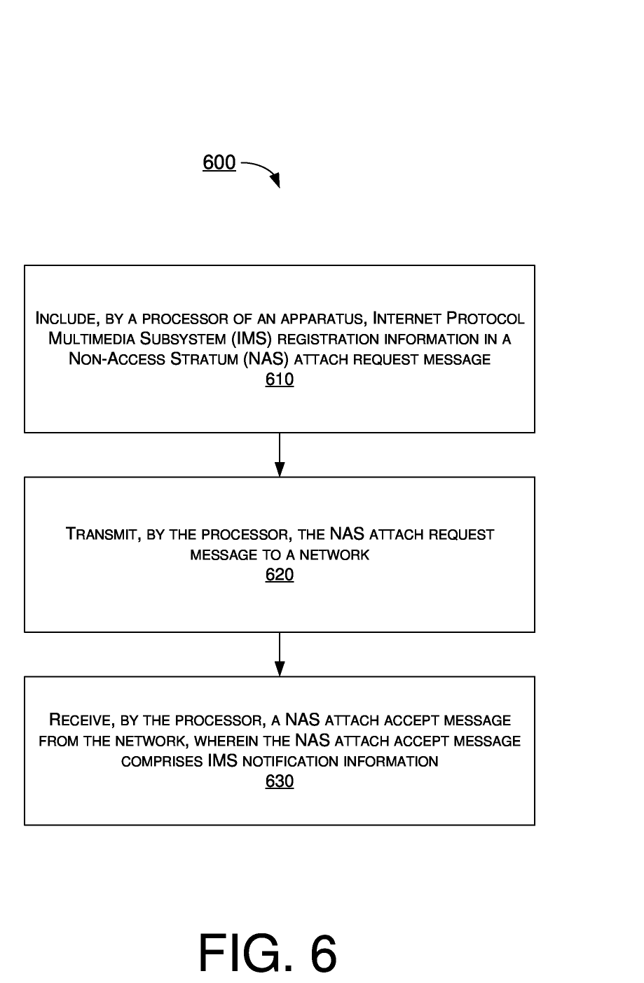

FIG. 6 illustrates an example process 600 in accordance with an implementation of the present disclosure. Process 600 may be an example implementation of above scenarios/schemes, whether partially or completely, with respect to improving IMS message flow for voice services of the present disclosure. Process 600 may represent an aspect of implementation of features of communication apparatus 510. Process 600 may include one or more operations, actions, or functions as illustrated by one or more of blocks 610 to 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 510 or any suitable UE or machine type devices. Solely for illustrative purposes and without limitation, process 600 is described below in the context of communication apparatus 510. Process 600 may begin at block 610.

At block 610, process 600 may involve processor 512 of communication apparatus 510 including IMS registration information in a NAS attach request message. Process 600 may proceed from block 610 to block 620.

At block 620, process 600 may involve processor 512 of communication apparatus 510 transmitting, via transceiver 516, the NAS attach request message to a network. Process 600 may proceed from block 620 to block 630.

At block 630, process 600 may involve processor 512 of communication apparatus 510 receiving, via transceiver 516, a NAS attach accept message from the network. The NAS attach accept message may comprise IMS notification information.

In some implementations, process 600 may involve processor 512 of communication apparatus 510 receiving, via transceiver 516, a SIB comprising an IMS signaling optimization capability indicator from the network. The IMS signaling optimization capability indicator may indicate that the network supports an IMS registration optimization.

In some implementations, process 600 may involve processor 512 of communication apparatus 510 determining not to initiate a SIP registration procedure in an event that the IMS signaling optimization capability indicator is received from the network.

In some implementations, the IMS registration information may comprise at least one of an IMS public user identity (IMPU) and an IMS private identity (IMPI).

In some implementations, the IMS registration information may be transmitted by a NAS signaling via a signaling radio bearer (SRB) over a control plane (CP).

In some implementations, in the NAS attach request message, a request type may be set to initial attach (IA) for an IMS Packet Data Network (PDN) connection.

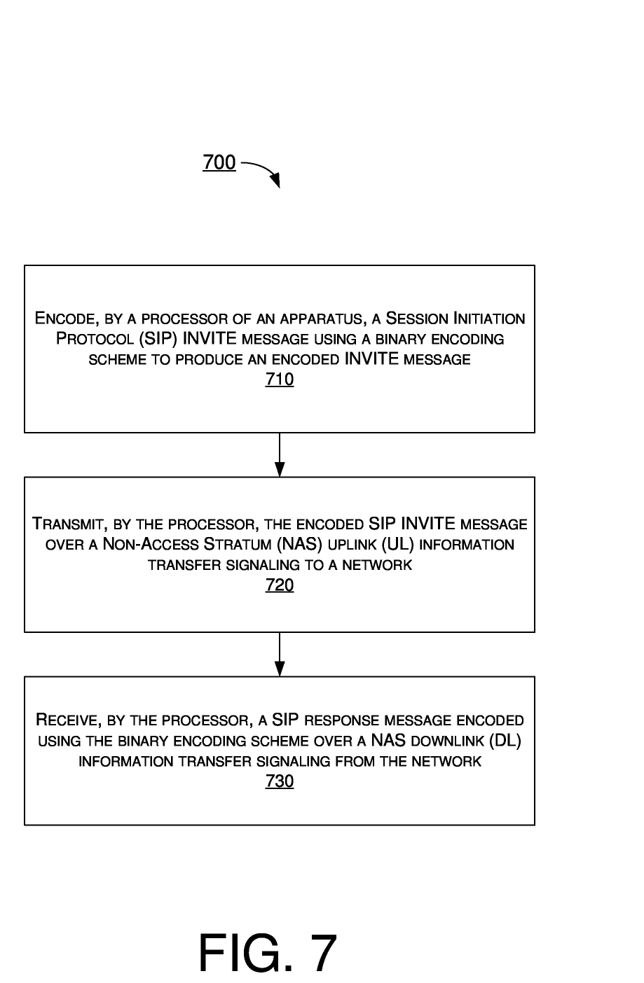

FIG. 7 illustrates an example process 700 in accordance with an implementation of the present disclosure. Process 700 may be an example implementation of above scenarios/schemes, whether partially or completely, with respect to improving IMS message flow for voice services of the present disclosure. Process 700 may represent an aspect of implementation of features of communication apparatus 510. Process 700 may include one or more operations, actions, or functions as illustrated by one or more of blocks 710 to 730. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by communication apparatus 510 or any suitable UE or machine type devices. Solely for illustrative purposes and without limitation, process 700 is described below in the context of communication apparatus 510. Process 700 may begin at block 710.

At block 710, process 700 may involve processor 512 of communication apparatus 510 encoding a SIP INVITE message using a binary encoding scheme to produce an encoded INVITE message. Process 700 may proceed from block 710 to block 720.

At block 720, process 700 may involve processor 512 of communication apparatus 510 transmitting, via transceiver 516, the encoded SIP INVITE message over a NAS UL information transfer signaling to a network. Process 700 may proceed from block 720 to block 730.

At block 730, process 700 may involve processor 512 of communication apparatus 510 receiving, via transceiver 516, a SIP response message encoded using the binary encoding scheme over a NAS DL information transfer signaling from the network.

In some implementations, process 700 may involve processor 512 of communication apparatus 510 transmitting, via transceiver 516, a voice media by RTP packets over a default bearer of an IMS PDN connection using NIDD.

In some implementations, the binary encoding scheme may comprise an I1 encoding scheme.

In some implementations, at least one of a dialing number and a call type indicator indicating a voice call or a video call in the SIP INVITE message may be encoded by the binary encoding scheme.

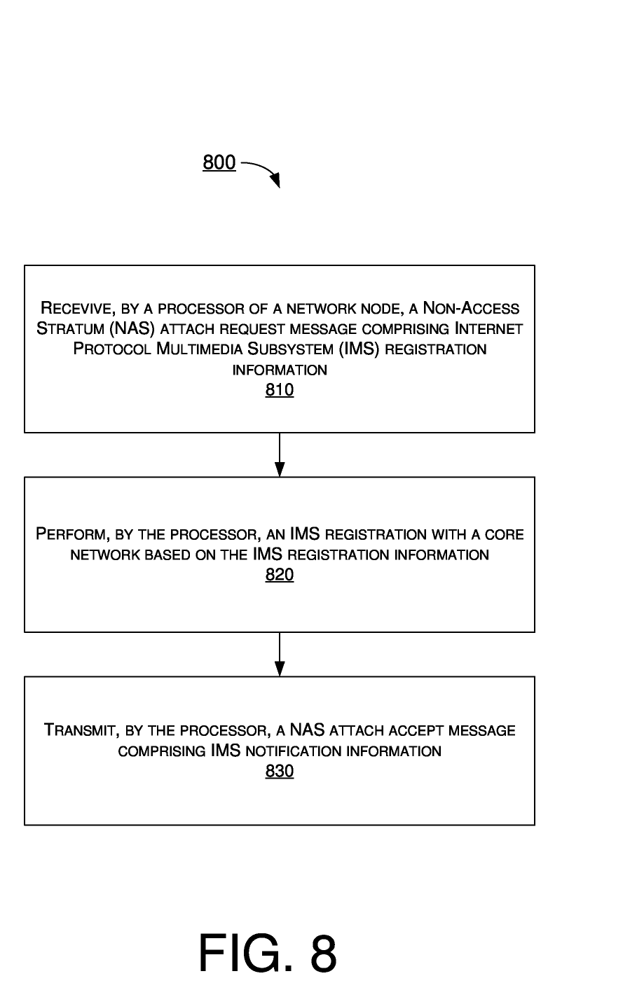

FIG. 8 illustrates an example process 800 in accordance with an implementation of the present disclosure. Process 800 may be an example implementation of above scenarios/schemes, whether partially or completely, with respect to the improved connection release procedure of the present disclosure. Process 800 may represent an aspect of implementation of features of network apparatus 520. Process 800 may include one or more operations, actions, or functions as illustrated by one or more of blocks 810 to 830. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may be implemented by network apparatus 520 or any suitable network nodes or base stations. Solely for illustrative purposes and without limitation, process 800 is described below in the context of network apparatus 520. Process 800 may begin at block 810.

At block 810, process 800 may involve processor 522 of network apparatus 520 receiving, via transceiver 526, a NAS attach request message comprising IMS registration information. Process 800 may proceed from block 810 to block 820.

At block 820, process 800 may involve processor 522 of network apparatus 520 performing an IMS registration with a core network based on the IMS registration information. Process 800 may proceed from block 820 to block 830.

At block 830, process 800 may involve processor 522 of network apparatus 520 transmitting, via transceiver 526, a NAS attach accept message comprising IMS notification information.

In some implementations, process 800 may involve processor 522 of network apparatus 520 broadcasting, via transceiver 526, a SIB comprising an IMS signaling optimization capability indicator. The IMS signaling optimization capability indicator may indicate that the network node supports an IMS registration optimization.

In some implementations, the network node comprises a Mobility Management Entity (MME).

In some implementations, the IMS registration information may comprise at least one of an IMS public user identity (IMPU) and an IMS private identity (IMPI).

In some implementations, the IMS registration information may be received by a NAS signaling via a signaling radio bearer (SRB) over a control plane (CP).

In some implementations, in the NAS attach request message, a request type may be set to initial attach (IA) for an IMS Packet Data Network (PDN) connection.

In some implementations, process 800 may involve processor 522 of network apparatus 520 receiving, via transceiver 526, a SIP INVITE message encoded using a binary encoding scheme over a NAS UL information transfer signaling. In some implementations, process 800 may involve processor 522 of network apparatus 520 transmitting, via transceiver 526, a SIP response message encoded using the binary encoding scheme over a NAS DL information transfer signaling.

In some implementations, process 800 may involve processor 522 of network apparatus 520 receiving, via transceiver 526, a voice media by RTP packets over a default bearer of an IMS PDN connection using NIDD.

In some implementations, process 800 may involve processor 522 of network apparatus 520 configuring a rule to a serving gateway (S-GW) for using NIDD.

In some implementations, the binary encoding scheme may comprise an I1 encoding scheme.

### Additional Notes

The herein-described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected", or "operably coupled", to each other to achieve the desired functionality, and any two components capable of being so associated can also be viewed as being "operably couplable", to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to implementations containing only one such recitation, even when the same claim includes the introductory phrases "one or more" or "at least one" and indefinite articles such as "a" or "an," e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of "two recitations," without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
including, by a processor of an apparatus, Internet Protocol Multimedia Subsystem (IMS) registration information in a Non-Access Stratum (NAS) attach request message;
transmitting, by the processor, the NAS attach request message to a network; and
receiving, by the processor, a NAS attach accept message from the network, wherein the NAS attach accept message comprises IMS notification information.

2. The method of claim 1, further comprising:
receiving, by the processor, a system information block (SIB) comprising an IMS signaling optimization capability indicator from the network,
wherein the IMS signaling optimization capability indicator indicates that the network supports an IMS registration optimization.

3. The method of claim 1, further comprising:
determining, by the processor, not to initiate a Session Initiation Protocol (SIP) registration procedure in an event that the IMS signaling optimization capability indicator is received from the network.

4. The method of claim 1, wherein the IMS registration information comprises at least one of an IMS public user identity (IMPU) and an IMS private identity (IMPI).

5. The method of claim 1, wherein the IMS registration information is transmitted by a NAS signaling via a signaling radio bearer (SRB) over a control plane (CP).

6. The method of claim 1, wherein, in the NAS attach request message, a request type is set to initial attach (IA) for an IMS Packet Data Network (PDN) connection.

7. A method, comprising:
encoding, by a processor of an apparatus, a Session Initiation Protocol (SIP) INVITE message using a binary encoding scheme to produce an encoded INVITE message;
transmitting, by the processor, the encoded SIP INVITE message over a Non-Access Stratum (NAS) uplink (UL) information transfer signaling to a network; and
receiving, by the processor, a SIP response message encoded using the binary encoding scheme over a NAS downlink (DL) information transfer signaling from the network.

8. The method of claim 7, further comprising:
transmitting, by the processor, a voice media by Real-time Transport Protocol (RTP) packets over a default bearer of an Internet Protocol (IP) Multimedia Subsystem (IMS) Packet Data Network (PDN) connection using Non-IP Data Delivery (NIDD).

9. The method of claim 7, wherein the binary encoding scheme comprises an I1 encoding scheme.

10. The method of claim 7, wherein at least one of a dialing number and a call type indicator indicating a voice call or a video call in the SIP INVITE message is encoded by the binary encoding scheme.

11. A method, comprising:
receiving, by a processor of a network node, a Non-Access Stratum (NAS) attach request message comprising Internet Protocol Multimedia Subsystem (IMS) registration information;
performing, by the processor, an IMS registration with a core network based on the IMS registration information; and
transmitting, by the processor, a NAS attach accept message comprising IMS notification information.

12. The method of claim 11, further comprising:
broadcasting, by the processor, a system information block (SIB) comprising an IMS signaling optimization capability indicator,
wherein the IMS signaling optimization capability indicator indicates that the network node supports an IMS registration optimization.

13. The method of claim 11, wherein the network node comprises a Mobility Management Entity (MME).

14. The method of claim 11, wherein the IMS registration information comprises at least one of an IMS public user identity (IMPU) and an IMS private identity (IMPI).

15. The method of claim 11, wherein the IMS registration information is received by a NAS signaling via a signaling radio bearer (SRB) over a control plane (CP).

16. The method of claim 11, wherein, in the NAS attach request message, a request type is set to initial attach (IA) for an IMS Packet Data Network (PDN) connection.

17. The method of claim 11, further comprising:
receiving, by the processor, a Session Initiation Protocol (SIP) INVITE message encoded using a binary encoding scheme over a Non-Access Stratum (NAS) uplink (UL) information transfer signaling; and
transmitting, by the processor, a SIP response message encoded using the binary encoding scheme over a NAS downlink (DL) information transfer signaling.

18. The method of claim 17, further comprising:
receiving, by the processor, a voice media by Real-time Transport Protocol (RTP) packets over a default bearer of an Internet Protocol (IP) Multimedia Subsystem (IMS) Packet Data Network (PDN) connection using Non-IP Data Delivery (NIDD).

19. The method of claim 17, further comprising:
configuring, by the processor, a rule to a serving gateway (S-GW) for using Non-IP Data Delivery (NIDD).

20. The method of claim 17, wherein the binary encoding scheme comprises an I1 encoding scheme.
